(19) United States
(12) Patent Application Publication
(10) Pub. No.: US 2008/0248822 A1
(43) Pub. Date: Oct. 9, 2008

(54) Link adaptation in mobile telecommunication system

(75) Inventors: Esko Jarvinen, Espoo (FI); Lassi Hyvonen, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/808,904

(22) Filed: Jun. 13, 2007

(30) Foreign Application Priority Data
Apr. 3, 2007 (FI) 20075227

(51) Int. Cl. H04Q 7/20; H04B 1/10; H04B 15/00; H04B 17/00

(52) U.S. Cl. 455/509; 370/329; 455/452.1; 455/456.1; 455/522; 455/62; 455/63.1; 455/67.11

(57) ABSTRACT

A method for managing transmission conditions in a mobile telecommunication system according to movement of a mobile terminal is provided. The mobile terminal is having a communication link with a base station. The movement of the mobile terminal is monitored, and then a database is checked for the most optimal transmission conditions for the monitored movement of the mobile terminal, and action is taken to change the transmission conditions of the communication link upon detecting, in the database, transmission conditions providing a more optimal communication link for the current movement of the mobile terminal than the transmission conditions currently being used for the communication link.

### FIELD

The invention relates to radio link adaptation in a mobile telecommunication system.

### BACKGROUND

Radio link adaptation is an important factor in a mobile telecommunication system in order to react to variations in a radio channel environment. One reason for the radio link adaptation is to overcome attenuation of information signals in a radio channel. The attenuation is typically caused by path loss, shadowing, and fading. Path loss is a function of a distance between a transmitter and a receiver, shadowing is caused by objects between the transmitter and the receiver, and fast fading results in a multipath propagation of information signals. Transmit power control is a known scheme to combat all types of attenuation. Modulation and coding schemes may also be changed according to radio channel properties, or a diversity transmission and/or reception may be initialized to improve the reliability of transmission.

A reaction to changing radio channel properties is typically carried out by performing a channel estimation procedure based on a pilot sequence transmitted from the radio transmitter to the radio receiver. On the basis of the result of the channel estimation, the radio receiver instructs the radio transmitter to change the transmission parameters to ones that are more optimal for the current radio channel environment. A problem with the known scheme lies in the reaction to the changes in the radio channel properties. In other words, action is taken after the radio channel properties have changed, i.e. the quality of a transmitted information signal has degraded before action is taken to remedy the degradation.

### BRIEF DESCRIPTION OF THE INVENTION

An object of the invention is to provide an improved solution for radio link adaptation.

According to an aspect of the invention, there is provided a method, comprising: monitoring movement of a mobile terminal having a communication link with a base station of a mobile telecommunication system, checking a database for transmission conditions of the communication link that are the most optimal according to a determined optimality criterion for current movement of the mobile terminal, and taking action to change the transmission conditions of the communication link upon detecting, in the database, transmission conditions providing a more optimal communication link for the current movement of the mobile terminal than the transmission conditions currently being used for the communication link.

According to another aspect of the invention, there is provided an apparatus, comprising an interface configured to receive information on a geographical location of a mobile terminal having a communication link with a base station of a mobile telecommunication system. The apparatus further comprises a processing unit configured to check a database for transmission conditions of the communication link that are the most optimal according to a determined optimality criterion for current movement of the mobile terminal, and to take action to change the transmission conditions of the communication link upon detecting, in the database, transmission conditions providing a more optimal communication link for the current movement of the mobile terminal than the transmission conditions currently being used for the communication link.

According to another aspect of the invention, there is provided an apparatus, comprising: means for monitoring movement of a mobile terminal having a communication link with a base station of a mobile telecommunication system, means for checking a database for transmission conditions of the communication link that are the most optimal according to a determined optimality criterion for current movement of the mobile terminal, and means for taking action to change the transmission conditions of the communication link upon detecting, in the database, transmission conditions providing a more optimal communication link for the current movement of the mobile terminal than the transmission conditions currently being used for the communication link.

According to another aspect of the invention, there is provided a computer program distribution medium readable by a computer and encoding a computer program of instructions for executing a computer process, comprising: monitoring movement of a mobile terminal having a communication link with a base station of a mobile telecommunication system, checking a database for transmission conditions of the communication link that are the most optimal according to a determined optimality criterion for current movement of the mobile terminal, and taking action to change the transmission conditions of the communication link upon detecting, in the database, transmission conditions providing a more optimal communication link for the current movement of the mobile terminal than the transmission conditions currently being used for the communication link.

According to another aspect of the invention, there is provided a data structure, comprising: a first data field comprising a plurality of location values representing different geographical locations, a second data field comprising a plurality of transmission condition sets, wherein each transmission condition set is linked to one of the plurality of location values and each transmission condition set comprises one or more transmission condition groups, comprising one or more transmission conditions, and a third data field comprising a plurality of transmission property values representing quality of transmission, wherein each transmission quality value is linked to a transmission condition group.

### LIST OF DRAWINGS

In the following, the invention will be described in greater detail with reference to the embodiments and the accompanying drawings, in which

FIG. 1 illustrates a typical radio environment;

FIG. 2 illustrates block diagrams of a mobile terminal and a base station of a mobile telecommunication system;

FIG. 3 shows an exemplary structure of a database according to an embodiment of the invention;

FIG. 4 is a flow diagram illustrating a process for constructing and updating a database used in adaptation of a communication link according to an embodiment of the invention; and

FIG. 5 is a flow diagram illustrating a process for managing transmission conditions according to an embodiment of the invention.

### DESCRIPTION OF EMBODIMENTS

A radio signal propagating through a radio channel suffers from attenuation caused by path loss, shadowing, and fast fading. The path loss is an overall decrease in the strength of the radio signal as the distance between a radio transmitter and a radio receiver increases. The physical processes causing path loss include outward spreading of waves from a transmitter antenna and obstructing effects of trees and buildings. A typical radio system may involve variations in path loss up to 150 dB over a coverage area of the system. The degree of the actual path loss is also a function of a type of environment between the transmitter and the receiver. In an urban environment, path loss is significantly higher than in suburban or rural areas.

Shadowing is superimposed on path loss, and it changes more rapidly than path loss and with significant variations over distances of hundreds of meters. Generally, shadowing involves variations up to 20 dB, and it arises due to the varying nature of the particular obstructions between a base station and a mobile terminal, such as tall buildings, hills or dense woods. Additionally, a user of the mobile terminal may cause shadowing when talking on the phone such that the user's head is located between the mobile terminal and a base station communicating with the mobile terminal. While the density of human tissue is not even comparable with the density of buildings and woods, the head is located such that the radio waves cannot easily go around the head due to the close proximity between an antenna of the mobile terminal and the head.

Fast fading involves variations on the scale of half-wavelength of the radio signal and frequently introduces variations as large as 35 to 40 dB. The fast fading results from constructive and destructive interference between multiple radio waves arriving at the radio receiver. In addition to the path loss, shadowing, and fast fading, a radio signal in the radio channel suffers from thermal noise and interference caused by other radio signals on the same frequency band.

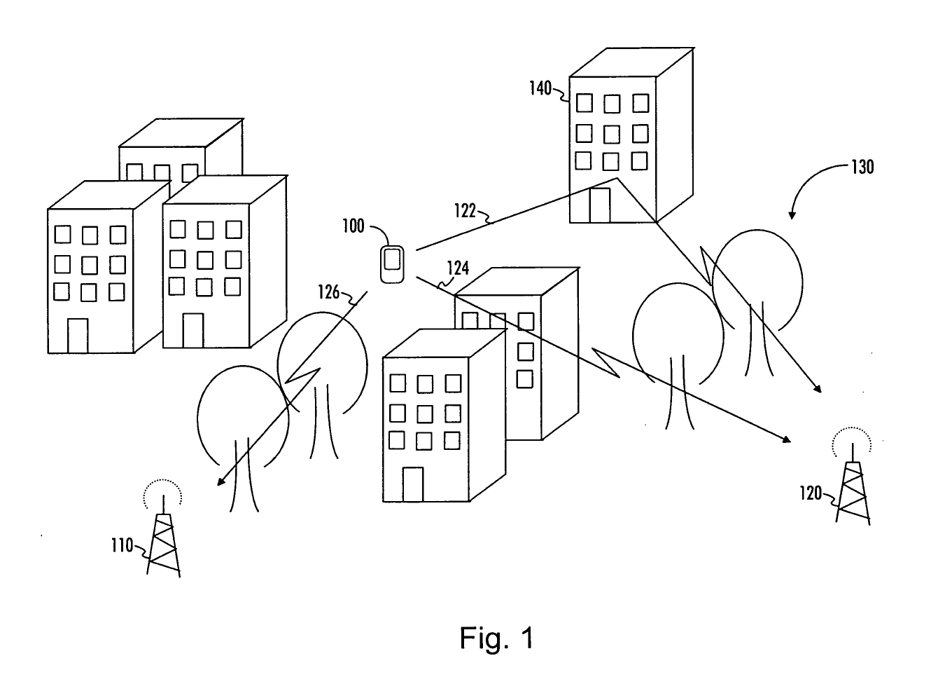

With reference to FIG. 1, a mobile terminal 100 is currently communicating with a first base station 120. A radio channel between the mobile terminal 100 and the first base station 120 belonging to a radio access network of a mobile telecommunication system affects signals exchanged between the mobile terminal 100 and the first base station with path loss, shadowing, and fast fading. The shadowing is caused by woods 130, buildings, and other obstacles blocking a line-of-sight between the mobile terminal 100 and the first base station 120. The fast fading is caused by multipath propagation of the signals and destructive summation of different multipath components in a receiver. The destructive summation may occur when a signal which has traveled through a signal path 122 (reflection from a building 140) is summed with a signal traveled through a signal path 124 (a direct path) in approximately opposite phases.

Handing a communication link over to another base station 110 may improve the reliability of data transmission. In other words, a communication link 126 between the mobile terminal 100 and the other base station 110 may introduce less attenuation to transmitted signals. The other base station may belong to the same radio access network as the first base station or to another radio access network. There are, however, other possibilities for improving the reliability of data transmission to/from the mobile terminal 100, as will be described below.

Several known solutions exist for tracking the location of a mobile terminal. Modern mobile terminals may be provided with a positioning device as an add-on device or as a fixed component of the mobile terminal. The positioning device may utilize Global Positioning System (GPS), Galileo, or another satellite positioning system. Alternatively, base stations of a radio access network may monitor the location of the mobile terminal by calculating signal propagation delays between the mobile terminal and a plurality of base stations capable of communicating with the mobile terminal.

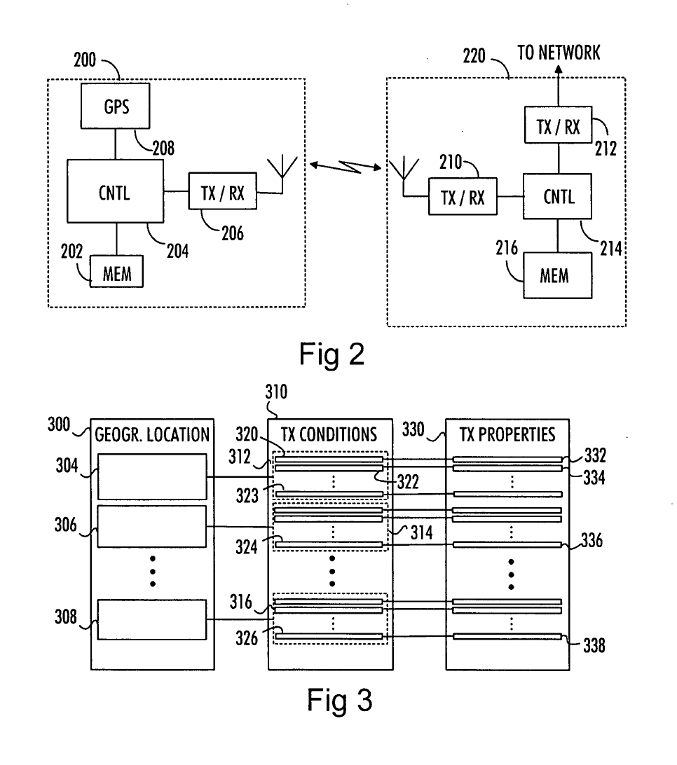

FIG. 2 illustrates block diagrams of a mobile terminal 200 and a base station 220 of a typical mobile telecommunication network. The base station 220 comprises a first communication interface 210 to provide an air interface connection to one or several mobile terminals, such as mobile terminal 200. The first communication interface 210 may perform analog operations necessary for transmitting and receiving radio signals. Such operations may include analog filtering, amplification, up-/down conversions, and A/D (analog-to-digital) or D/A (digital-to-analog) conversion.

The base station 220 may further comprise a second communication interface 212 to provide a wired connection to the network of the mobile telecommunication system. The network of the mobile telecommunication system may provide connections to other networks, such as the Internet and Public Switched Telephone Network (PSTN). The second communication interface 212 may be connected to a radio network controller controlling the operation of the base station 220.

The base station 220 further comprises a processing unit 214 to control functions of the base station 220. The processing unit 214 handles establishment, operation and termination of radio connections with the mobile terminals the base station 220 is serving. The processing unit 214 may control the radio connections on the basis of instructions received from the radio network controller. The processing unit 214 may be implemented by a digital signal processor with suitable software embedded in a computer readable medium, or by separate logic circuits, for example with ASIC (Application Specific Integrated Circuit).

The base station 220 may further comprise a memory unit 216 storing instructions for controlling the operation of the processing unit 214. The memory unit 216 may store transmission parameters related to a communication link between the base station 220 and the mobile terminal 200. The memory unit 216 may additionally store a data structure to be used for controlling transmission conditions of the communication link between the base station 220 and the mobile terminal 200.

The mobile terminal 200 may comprise a communication interface 206 to provide a radio connection with the base station 220. The communication interface 206 may perform analog operations necessary for transmitting and receiving radio signals.

The mobile subscriber unit 200 may further comprise a processing unit 204 to control functions of the mobile subscriber unit 200. The processing unit 204 may handle establishment, operation and termination of radio connections with the base station 220. The processing unit 204 may be implemented by a digital signal processor with suitable software embedded in a computer readable medium, or by separate logic circuits, for example with ASIC (Application Specific Integrated Circuit).

The mobile subscriber unit 200 may further comprise a memory unit 202 storing instructions for controlling the operation of the processing unit 204. The memory unit 202 may store transmission parameters related to the communication link between the base station 220 and the mobile terminal 200. The memory unit 202 may additionally store a data structure to be used for controlling transmission conditions of the communication link between the base station 220 and the mobile terminal 200.

Furthermore, the mobile terminal may comprise a positioning device 208 which is configured to determine a geographical location of the mobile terminal. The positioning device 208 may be configured to monitor the geographical location of the mobile terminal in real time by communicating with one or more satellites of a satellite positioning system, such as GPS, assisted GPS (A-GPS), or Galileo. Other alternatives for tracking the location and the movement of the mobile terminal include providing motion sensors in the positioning device 208, tracking the location of the mobile terminal with triangular measurements performed by a mobile telecommunication network. An example of the triangular measurements is Enhanced Observed Time Difference (EOTD) utilized in some mobile telecommunication networks. Several of the above-mentioned positioning schemes may be combined when determining the geographical location of the mobile terminal. The results obtained through different schemes may be averaged to minimize the effect of a positioning error.

The mobile terminal may additionally comprise a user interface (not shown) for interaction with a user of the mobile terminal. The user interface may be used not only for providing the user with instructions and other information but also for enabling the user to give instructions and control the operation of the mobile terminal. The user interface may comprise a display unit, a keyboard or a keypad, a microphone, and a loudspeaker.

When provided with knowledge of data transmission properties (or quality measures of a communication link) obtainable with different transmission conditions from a given geographical location, one may select appropriate transmission conditions for a mobile terminal located in the geographical location or arriving shortly at the geographical location with no need to measure properties of the radio channel environment and react to the changing environment. In other words, optimal transmission conditions may be selected before a change in the radio channel environment to prevent the degradation of signals.

Embodiments of the invention are based on monitoring the geographical location of the mobile terminal having a communication link with a base station of a mobile telecommunication system and predicting movement of the mobile terminal from one or more of the monitored geographical locations of the mobile terminal. Then, a database is checked for the most optimal transmission conditions for a geographical location associated with the predicted movement of the mobile terminal. Upon detecting, in the database, transmission conditions providing a more optimal connection for the geographical location than the ones currently in use for the communication link, action is taken to change the transmission conditions of the communication link to the more optimal ones.

Accordingly, the selection of appropriate transmission conditions for each geographical location is based on utilizing the database describing properties of the communication link with different transmission conditions in different geographical locations. The database may be constructed from measurements carried out by measuring, for example, reception signal strengths or other communication quality metrics obtained from a plurality of geographical locations. With respect to each location, one or more reception signal strengths may be measured, each with different transmission conditions. The database may be updated constantly with new information on communication qualities in different locations in order to keep the database up-to-date.

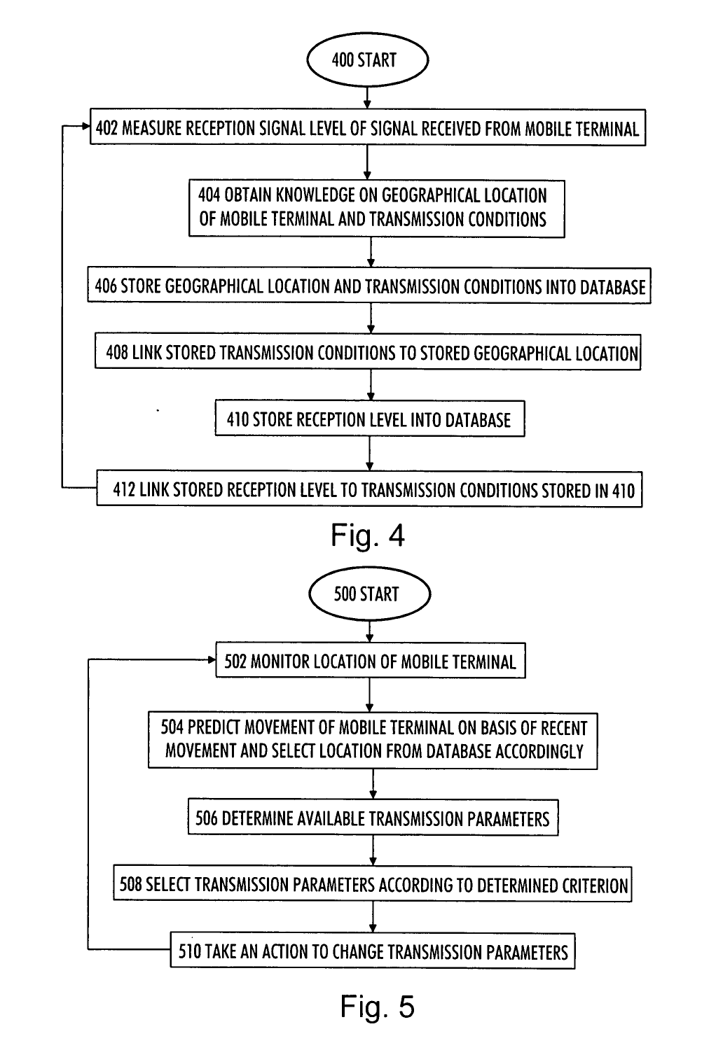

Measurement and database construction operations may be carried out by a base station. Referring to FIG. 4, the construction of a database is started in block 400. The base station measures the level of a signal received from a given mobile terminal in block 402 and in block 404 obtains knowledge of the geographical location of the mobile terminal at the time of transmission of the signal and transmission conditions used in the transmission of the signal. The reception level of the signal may be a received signal strength indicator (RSSI) calculated in any case by the base station for other purposes. Accordingly, no need exists to increase the complexity of the base station with additional measurement functionalities. As an alternative to the reception signal level, another communication link quality indicator may be measured, such as a signal-to-interference power ratio. The geographical location of the mobile terminal may be determined in the mobile terminal and transmitted periodically to the base station as signaling information in a control channel. The mobile terminal may be adapted to attach a time stamp (or another time indicator) to the transmitted geographical location information to enable the base station to track the movement of the mobile terminal. Transmission of the signaling information related to the geographical information may be defined in a communication protocol used in the communication between the mobile terminal and the base station. Accordingly, no need exists to use the resources of data channels for the transmission of the location information. The base station may obtain the knowledge of the transmission conditions from a communication protocol used in the transmission, or information on at least some of the transmission conditions may be communicated from the mobile terminal to the base station.

Referring to FIG. 3 illustrating a database (a data structure) according to an embodiment of the invention, the base station then in block 406 stores the location of the mobile terminal in a first data field 300 in the database to form a location value 304 representing the geographical location of the mobile terminal. In the same block 406, the base station stores the transmission conditions used in the transmission of a measured signal in a second data field 310 of the database to form a transmission condition group 320, and in block 408 links the transmission condition group 320 to the geographical location of the mobile terminal stored as the location value 304 in the first data field 300 of the database in block 406. Finally, the base station stores, in block 410, a measured reception level of the signal received from the mobile terminal in a third data field 330 of the database to form a transmission property value 332 and to link, in block 412, the stored transmission property value to the transmission parameter group 320 used in the transmission of the signal in question and stored in block 406.

In a similar way, the base station may measure reception levels of signals received from the same mobile terminal or from other mobile terminals at different geographical locations and with different transmission conditions, and fill the first data field, i.e. a geographical location data field 300, with location values 304, 306, and 308 representing geographical locations for which measurements have been carried out. In other words, the process returns from block 412 to block 402. Accordingly, the base station may also store transmission conditions used in the transmission of each signal, for which the reception level has been measured, in the second data field 310 as a transmission condition group 322, 324, or 326 and link each stored transmission condition group 322, 324, and 326 to a corresponding location value 304 to 308. Finally, the base station may store the measured reception levels in the third data field 330 as transmission property values 334, 336, and 338 and link the stored transmission property values 334, 336, and 338 to the corresponding transmission parameter groups 322, 324, and 326.

When a plurality of signals with different transmission conditions are measured with respect to the same geographical location, i.e. the same location value 304, 306, or 308, the transmission condition groups associated with the same location value may be further grouped to form a transmission condition set. Referring to FIG. 3, transmission condition groups 320, 322, and 323 for a transmission condition set 312 are linked to the location value 304. Similarly, transmission condition sets 314 and 316 are formed and linked to the corresponding location values 306 and 308, respectively.

In an alternative embodiment, the database may be constructed such that the transmission property values included in the third data field 330 may be linked directly to the corresponding location values and each transmission parameter group associated with one of the transmission property values may be linked to the corresponding transmission property value. In other words, the order of the second data field 310 and the third data field 330 may be reversed compared to that illustrated in FIG. 3. Furthermore, the transmission property values included in the third data field 330 and the transmission condition groups included in the second data field 310 may both be linked directly to the geographical location values included in the first data field to enable access from a given geographical location value directly either to the transmission condition groups or to the transmission property values. Additionally, the transmission condition groups may be linked directly to the corresponding transmission property values.

The database may be updated constantly with new data to adapt the database to changes in the radio environments related to different geographical locations. Accordingly, when the base station may constantly monitor RSSI values and/or other communication quality metrics of signals received from mobile terminals communicating with the base station, the base station may update the database with new transmission property values and/or new transmission conditions. Given transmission property values may be averaged over the plurality of measurements to average the different transmission properties associated with different mobile terminals. An averaging window may be of determined length to enable sufficient averaging but prevent very old transmission property values from having a significant effect on the averaging. The radio environment may have changed due to newly constructed buildings, for example.

A plurality of base stations may utilize and update a common database to construct an extensive database from a variety of different geographical locations with a variety of transmission conditions and transmission qualities associated with the transmission conditions.

The transmission conditions may include radio system parameters, such as the transmission frequency and a serving base station but also other conditions such as bearing of the mobile terminal and transmit power. In general, the transmission conditions include options available to the mobile terminal to affect the quality of the communication link between the mobile terminal and the base station. One or more of the above-mentioned transmission conditions may be stored in a transmission condition group of a transmission condition set associated with a given geographical location. Preferably, two arbitrarily selected transmission condition groups belonging to the same transmission condition set have different transmission conditions. When a transmission condition group having the same transmission conditions as one stored previously is to be stored in the same transmission condition set, a property value of the older transmission condition group may be replaced with a property value of the new transmission condition group. This reflects a change in the radio environment associated with a given geographical location with the same transmission conditions, and the database is updated accordingly.

The transmission frequency is a parameter known to the base station from a transmission protocol. With respect to the serving base station as a transmission condition, the base station carrying out the measurement and updating the database with a new geographical location, transmission condition group, and/or transmission property value, may add its own unique identifier to the transmission condition group to indicate that a given transmission property value (or values) were obtained when using the particular base station for communication. The base station may be a base station configured to communicate according to at least one of the following data transmission standards: GSM (Global System for Mobile Communications), UMTS (Universal Mobile Telecommunication System) based on W-CDMA (Wideband Code Division Multiple Access) and/or OFDMA (Orthogonal Frequency Division Multiple Access) and SC-FDMA (Single Carrier Frequency Division Multiple Access), WLAN (Wireless Local Area Network). As mentioned above, the database may be updated by multiple base stations, and the base stations may utilize different communication standards.

The transmit power level may be communicated from the mobile terminal to the base station, or it may be tracked with a transmit power control procedure utilized in many mobile telecommunication systems, including UMTS. The bearing of the mobile terminal during the transmission may be determined by motion sensors or a compass provided in the mobile terminal. With the knowledge of the location of the base station, the mobile terminal is able to determine its bearing with respect to the base station. Locations of base stations may be stored in the database by utilizing the same notation as that used for storing the location values.

Above, the reception levels of the received signals were used as the transmission property values included in the third data field 330 of the database. In addition to or instead of metrics describing the quality of the communication link, other types of transmission property values may be used. The other types of transmission property values may include, for example, cost of the communication link. The value of the reception level reflects the quality of the radio environment, while the cost of the communication link refers to financial cost of the communication link. Information on the cost of the communication link may be stored as a transmission property value when adding a new transmission condition group to the database or when updating the database with a new cost value. The information on the cost of the communication link may be provided by an operator of the radio network.

In the description above, the base station measured and stored the database in a memory unit of a radio access network. Alternatively, the database may be stored in a memory unit of the mobile terminal. The measurements may still be carried out by the base station but the base station may inform the mobile terminal of the measurement results, and the mobile terminal may add the results (and other transmission property values), the transmission conditions, and the geographical location values to the database stored in the memory unit of the mobile terminal. Of course, the database may be stored in both the mobile terminal and the radio network.

The geographical resolution of the database may be selected, for example, according to available computational resources and/or memory capacity or according to the accuracy of the positioning system.

An example of the construction of a database according to an embodiment of the invention was described above. Next, utilization of the database in managing data transmission from the mobile terminal will be described. Naturally, the database may also be utilized in managing downlink transmission.

Let us assume that a mobile terminal having a communication link with a base station of a mobile telecommunication system is moving in a geographical area. The mobile terminal is using a given transmission condition group for transmitting data to the base station. Let us further assume that a procedure for selecting transmission conditions according to the movement of the mobile terminal is carried out in the mobile terminal. Accordingly, the procedure may be carried out by a processing unit of the mobile terminal (for example the processing unit 204 of FIG. 2). Referring to a flow diagram illustrated in FIG. 5, the procedure starts in block 500.

The movement of the mobile terminal is tracked in block 502 with the help of information received from a positioning device included in the mobile terminal. The geographical location of the mobile terminal may be tracked in real time or updated periodically. A short history of the movement of the mobile terminal may be stored into the memory unit of the mobile terminal to enable prediction of the movement. The prediction of the geographical location the mobile terminal is moving to is carried out in order to change the transmission conditions, if necessary, to more optimal ones before the transmission quality suffers from degradation.

The geographical location (a limited area) the mobile terminal will be entering next is predicted in block 504, for example, by extrapolating the latest movement of the mobile terminal, i.e. the stored history of the movement of the mobile terminal. The extrapolation may be performed by a determined prediction algorithm weighting samples representing the stored movement of the mobile terminal to predict the upcoming location of the mobile terminal. For example, if the stored movement history indicates that the mobile terminal has traveled through a straight path, the prediction algorithm may predict that the upcoming location of the mobile terminal is the next geographical location located along that straight path and included in the database. Accordingly, a geographical location value closest to the predicted next geographical location along the path of the mobile terminal is selected from the first data field 300 of the database in block 504.

Then, the transmission conditions to be used in the selected geographical location may be determined. First, a transmission condition set linked to the selected geographical location value may be determined by following a link from the selected geographical location value to the appropriate transmission condition set. Then, the transmission condition groups available to the mobile terminal in the geographical location selected in block 504 may be determined in block 506. It may be that the determined transmission condition set comprises transmitter parameter groups not available to the mobile terminal. They may be permanently unavailable or deactivated for the present. If it is known that the transmission condition set only comprises transmission condition groups available to the mobile terminal, block 506 may be omitted.

In block 508, transmission conditions to be used in the predicted geographical location are selected according to a determined criterion. The criterion may be given by a user of the mobile terminal, it may be given by a radio network serving the mobile terminal, or it may be determined in another way. The criterion may be at least one of the following criteria: higher reception signal level, lower power consumption of a transmitter, higher data rate, and lower data transmission cost. The criterion may be a conditional combination of a plurality of the above-mentioned criteria. The criterion may be, for example, to use the cheapest available connection, if the reception power level of the cheapest available connection remains above a determined threshold. Otherwise, the connection providing the highest reception power should be used. Alternatively, the criterion may be to obtain the highest possible reception signal level with the lowest possible transmit signal level. In such a case, the transmission signal levels included in the available transmission condition groups may be compared with the reception signal levels included in the transmission property values, and the transmission property group providing the highest ratio between the reception signal level and the transmission signal level may be selected.

The transmission condition group most suitable for the selected criterion may be selected in block 508 by comparing the transmission property values of the transmission condition groups. First, the transmission property values linked with the transmission condition groups available to the mobile terminal may be checked and compared considering the determined criterion. For example, if the criterion is to use the cheapest communication link available, a transmission property value indicating the lowest cost of the communication link may be selected. Then, a transmission condition group linked to the selected transmission property value may be selected as the transmission conditions to be used next.

Then, action is taken in block 510 to change the transmission conditions of the mobile terminal to ones corresponding to the transmission condition group selected in block 508. If the selected transmission condition group is the same as that currently in use, no need exists to change the transmission conditions. With respect to the exemplary transmission conditions listed above, i.e. transmission frequency, serving base station, transmit power, and bearing of the mobile terminal, a change of each of these parameters will be described next.

If the transmission frequency of a newly selected transmission condition group differs from that of the transmission condition group currently in use, the mobile terminal may communicate with a base station currently communicating with the mobile terminal about a change of transmission frequency. The communication between the mobile terminal and the base station may utilize frequency hopping, and a target frequency for the next frequency hop may be communicated from the mobile terminal to the base station. Then, the base station may acknowledge the change of transmission frequency, and communication about the newly assigned transmission frequency may be started. The newly assigned transmission frequency may be used only in uplink communications, or a downlink transmission frequency may be changed accordingly. In some mobile telecommunication systems, the transmission frequencies of the uplink and downlink data transmission are different and, therefore, properties of the uplink and downlink communication connections are different. For example, strongly fading frequencies of fast fading are typically different.

To implement frequency hopping according to an embodiment of the invention, a given transmission condition group of the database may include multiple (two or more) frequencies to be utilized in the transmission in a given geographical location or a group of adjacent locations forming an area. The frequencies may be selected and stored during the process described above with reference to FIG. 4. Frequencies providing the lowest correlation in the reception signal level in different geographical locations within the area may be selected as frequencies to be utilized in the frequency hopping. In such a selection scheme, locations in which the selected frequencies introduce the highest attenuations of a signal differ from each other, and implementing frequency hopping among such frequencies prevents the communication link from experiencing the strongest attenuations caused by fast fading. The frequency hopping may be implemented between these frequencies as long as the mobile terminal remains in the particular geographical location or area. The change of transmission frequency in the frequency hopping may be implemented periodically with fixed time intervals or according to measured communication quality, as will be described below.

If a serving base station designated in the newly selected transmission condition group differs from that designated in the transmission condition group currently in use, the mobile terminal may initiate a handover procedure for handing the mobile terminal over to the new base station designated in the newly selected transmission condition group. In many current mobile telecommunication systems, decisions of initializing handover procedures are carried out in a radio access network on the basis of downlink measurement results provided by the mobile terminal. Accordingly, the mobile terminal may transmit to the current serving base station measurement results indicating that the base station designated in the newly selected transmission condition group provides the mobile terminal with a better quality of service than the currently serving base station. Actual measurements carried out by the mobile terminal may currently indicate that the base station designated in the newly selected transmission condition group may not yet provide a better communication quality than the currently serving base station. The mobile terminal may, however, modify the actual measurement results to advance initialization of the handover procedure to enable the handover to be completed when the mobile terminal enters the geographical location predicted in block 404. The handover may be an intra-system handover in which the mobile terminal is handed over to another base station of the same mobile telecommunication system, or the handover may be an inter-system handover in which the mobile terminal is handed over to a base station of another mobile telecommunication system (for example handover from GSM to UMTS).

If the current bearing of the mobile terminal differs from that indicated in the selected transmission condition group, the mobile terminal may instruct the user of the mobile terminal to change the bearing of the mobile terminal towards the base station of a radio system indicated in the transmission condition group selected in block 508. In more detail, the mobile terminal may give instructions to turn the backside of the mobile terminal, i.e. the side opposite to a side typically pressed against the user's head during a phone call, towards the base station. This may be carried out in order to prevent the user's head from causing a shadowing effect. Alternatively, the radiation pattern of an antenna of the mobile terminal may not be uniform, and changing the bearing of the mobile terminal such that the main beam of the antenna is pointed towards the base station may improve the quality of the communication link significantly. The radiation pattern of the antenna of the mobile terminal may also be changed on the basis of the bearing of the mobile terminal and the knowledge of the direction of the base station with respect to the current location of the mobile terminal. Accordingly, the radiation pattern may be adjusted to focus a main beam of the antenna to the base station.

The instructions on changing the bearing of the mobile terminal may be provided through the user interface of the mobile terminal. If the user has established a voice communication link and is, therefore, having the mobile terminal near his/her head, the mobile terminal may give a determined audio signal instructing the user to either turn around or switch the mobile terminal from one ear to the other such that the backside of the mobile terminal is directed towards the base station. When the mobile terminal has detected a sufficient change in the bearing of the mobile terminal, the provision of the instructions on changing the bearing of the mobile terminal may be stopped. Alternatively, or additionally, the mobile terminal may provide instructions to change the bearing of the mobile terminal through a display unit of the mobile terminal. An indicator indicating the direction, in which the mobile terminal should be rotated may be illustrated in the display unit.

If the ratio between the reception signal level and the transmission signal level of the newly selected transmission condition group is higher than that of the currently used transmission condition group, it indicates that the radio channel between the mobile terminal and the base station, selected according to the transmission condition group selected in block 508, is better than that selected with the previous transmission conditions. The improvement in the radio channel may be utilized in a number of different ways. For example, a transmit power level of the mobile terminal may be lowered in order to save the battery and prolong the operational duration of the mobile terminal, and/or a data rate may be increased to provide a faster communication link between the mobile terminal and the base station. On the other hand, if the ratio between the reception signal level and the transmission signal level of the newly selected transmission condition group is lower than that of the currently used transmission condition group, indicating degradation in the radio channel, the transmit power level may be increased and/or the data rate may be lowered.

In addition to changing the transmission conditions according to the predicted movement of the mobile terminal only, communication quality indicators measured from signals received from the mobile terminal may be monitored within a time window of determined length, and the measured communication quality indicators may be utilized when selecting the transmission conditions for the predicted geographical location the mobile terminal will be entering or to change the transmission conditions currently in use. The time window may be reset, i.e. the monitoring may be restarted, when the transmission frequency is changed, because the radio channel properties are dependent on the transmission frequency, and monitoring over different frequencies would provide unreliable results.

The communication quality indicator may be, for example, a measured reception power level of a signal received from the mobile terminal and/or from the base station. Information related to the reception power levels measured by the base station may be communicated to the mobile terminal which may weight transmission property values of the database with the received reception signal level information. Several factors may affect the actual transmission properties with given transmission conditions. Such factors include season of the year, weather, traffic, etc. It may be possible that transmission properties of transmission parameters selected for the current geographical location of the mobile terminal indicate a good transmission quality but the reception power level starts to indicate a fading notch. Such a contradiction may be caused by the difference in the weather or season between the time instant at which the corresponding database section was updated and the current time instant.

Accordingly, the mobile terminal may react to the difference between the information stored in the database and the measured reception power level by changing the transmission conditions in order to prevent a further degradation in the reception signal level due to fading. The mobile terminal may, for example, initiate frequency hopping or change the transmission condition group to one having only a different transmission frequency while other conditions remain the same as those currently in use. If the transmission condition group currently in use comprises multiple transmission frequencies, the mobile terminal may initiate a change of transmission frequency to another frequency included in the transmission condition group. The mobile terminal may initiate the change of transmission frequency upon detecting a sufficiently high difference between the received reception power level information and the reception power level included in the database. Alternatively, the mobile terminal may initiate the change of the transmission frequency when the difference between the received reception power level information and the reception power level included in the database has remained higher than a determined threshold difference for a determined period of time.

As an alternative to a change of transmission frequency (or other transmission conditions), the mobile terminal may check the database for a neighboring (or nearby) location stored in the database in which the reception signal level is expected to be higher than in the current location. If such a location is detected, the mobile terminal may instruct the user of the mobile terminal to move towards the detected location in order to improve the quality of the communication link and/or prevent the communication link from dropping out due to fading. Referring to FIG. 5, the transmission property values associated with the predicted geographical location may be checked in block 506 and, if it is detected that none of the available transmission condition groups provide a sufficient transmission quality, the user may be instructed to move to a location providing a higher-quality communication link. This may be implemented by instructing, through the user interface, the user to move to a more suitable location. The direction may be indicated with an icon in the display unit and/or as a sound signal through the loudspeaker, for example.

Alternatively, the process illustrated in FIG. 5 may be carried out in the base station or in another element of a radio access network of the mobile telecommunication system communicating currently with the mobile terminal. In this example, the base station is used as an example of the element of the radio access network, but the element may be a radio network controller (a base station controller) as well. Consequently, the database is stored in a memory unit of the base station, and the process illustrated in FIG. 5 may be executed in a processing unit of the network element. The only practical difference in this embodiment with respect to that described above is that the base station and the mobile terminal exchange information necessary for carrying out the process. In block 502, the base station may receive information on the geographical location of the mobile terminal from the mobile terminal periodically with predetermined time intervals. As mentioned above, the mobile terminal may be configured to attach a time stamp (or another time indicator) to the transmitted geographical location information to enable the base station to track the movement of the mobile terminal. The geographical location may be transferred on a control channel as signaling information. Block 504 may be carried out, i.e. the movement of the mobile terminal may be predicted and the corresponding location selected from the database, as described above. Similarly, blocks 506 and 508 may be carried out as described above, and the transmission parameters may be selected for the predicted geographical location according to the determined criterion. The criterion may be decided by the base station, but if the criterion is determined by the mobile terminal or the user of the mobile terminal, the criterion may be communicated to the base station.

In block 510, the base station may communicate with the mobile terminal in relation to changing the transmission conditions. The base station may provide the mobile terminal with instructions necessary for changing the transmission conditions of the mobile terminal, i.e. the uplink transmission conditions. If the newly selected transmission condition group indicates a change of transmission frequency, the base station may instruct the mobile terminal to change the transmission frequency to the one defined in the transmission condition group selected in block 508. Similarly, if the selected transmission condition group indicates a change of serving base station, the base station may initiate a handover procedure for handing the mobile terminal over to another base station. In practice, the base station may provide a higher layer in charge of controlling the handover with corresponding information. The base station may, for example, modify downlink reception power level measurements received from the mobile terminal by increasing the level of a reception power level measurement associated with the base station to which the mobile terminal should be handed over. After the handover, the new serving base station may start the process illustrated in FIG. 5. If the newly selected transmission condition group indicates a change of the bearing of the mobile terminal, the base station may provide the mobile terminal with information on the new bearing associated with the transmission condition group selected in block 508.

Additionally, the base station may monitor the communication quality indicator measured from signals received from the mobile terminal within a determined time window and compare the communication quality indicator with the corresponding information in the transmission property values associated with the transmission condition group currently in use. Furthermore, the mobile terminal may monitor the communication quality indicator measured from a signal received from the base station, as described above, and transmit the communication quality indicator periodically to the base station. For example, the mobile terminal may monitor the communication quality indicator for a given period of time (a few seconds) during which the mobile terminal carries out several measurements, and then transmit a plurality of measurement results to the base station. Accordingly, no need exists to transmit each communication quality indicator separately but the plurality of communication quality indicators may be collected and then transmitted together for an analysis carried out by the base station. The base station may then weight the selection of the transmission condition group with the monitored communication quality indicator in a way similar to that carried out by the mobile terminal in the above description. If the base station decides to change the transmission condition group as a response to a sufficient difference between the monitored communication quality indicator and information stored in the database, the base station may instruct the mobile terminal to change the transmission condition group.

The decision about whether to guide the user to another geographical location in order to improve the quality of the communication link or to prevent outage may be performed in the same way in the base station as that used in the mobile terminal in the above description. When the base station decides that the mobile terminal should be moved to another location, the base station may provide the mobile terminal with instructions to instruct the user to move the mobile terminal and about the location to which the mobile terminal should be moved. The mobile terminal may then use a geographical map stored in the memory unit of the mobile terminal (may be the database described above or another map) and a current location of the mobile terminal to guide the user to the selected location.

The radio system (or systems) serving the mobile terminal may also use the geographical location of the mobile terminal and prediction of the movement of the mobile terminal for smart handovers. In conventional solutions, a handover is carried out on the basis of downlink reception signal level measurement results provided by mobile terminals, as described above. A mobile terminal measures reception power levels of pilot signals transmitted from different handover candidate base stations. A decision about initiating a handover procedure is then made in a radio access network on the basis of the measurement results. In such a solution, a problem may occur when a remote base station provides a higher reception signal level in a small geographical area due to line-of-sight, for example, than base stations closer to the mobile terminal. Accordingly, the mobile terminal may first be handed over to the remote base station and shortly again to a base station closer to the mobile terminal. This causes unnecessary signaling between the mobile terminal and the base stations.

According to an embodiment of the invention, the initiation of handover may be determined according to the predicted movement of the mobile terminal. The mobile terminal may be handed over to a handover candidate base station providing the largest coverage area along the predicted path of the mobile terminal. As a condition for the handover, it may be determined that the coverage areas between a serving base station and a handover target base station should overlap to ensure at least a determined minimum signal level in the communication link such that the communication link will not be dropped.

A radio system may also give profiles to mobile terminals within a radio access network of the radio system on the basis of the movement of the mobile terminals. The radio system may profile the mobile terminals according to their speeds into fixed, pedestrian, and vehicular mobile terminals, or according to their current location. Then, the radio system may use the profiles for transmitting profile-specific information to the mobile terminals. Such information may be a location-based advertisement, for example. With the speed-based profiling, the radio system may provide vehicular mobile terminals with information on gas stations, for example.

Above, the utilization of the database in the selection of transmission conditions has been described for uplink transmission, but it may be utilized in the same way for downlink transmission. For the downlink, the base station transmission frequency and the radio system may be changed similarly to that described above with respect to the uplink. Changing the bearing and the location of the mobile terminal is also analogous. The advantages achieved for the uplink when changing the bearing or the location of the mobile terminal in order to improve the reception signal level are also achieved for the downlink direction. The downlink transmission conditions may be managed by the base station or by the mobile terminal.

The database may also be stored in both the base station and the mobile terminal. The updates of the database may be communicated from the base station to the mobile terminal. The mobile terminal may manage the uplink transmission conditions on the basis of the movement of the mobile terminal, and the base station serving the mobile terminal may manage the downlink transmission conditions on the basis of received information on the movement of the mobile terminal. When serving a mobile terminal having no capability of managing the uplink transmission conditions on the basis of its movement, the base station may take care of managing also the uplink transmission conditions in a manner described above.

The embodiments of the invention described above are based on tracking the movement of the mobile terminal. Since the tracking and prediction of the movement of the mobile terminal is based on monitoring the current geographical location of the mobile terminal, the embodiments apply also to a case where the mobile terminal does not move, i.e. stays at the same geographical location for an extensive period of time.

Above, the utilization of the database has been described in a context wherein the transmission conditions are managed according to the predicted movement and/or the monitored location of the mobile terminal. This concept may also be reversed. Accordingly, the transmission conditions and properties of the communication link of a given mobile terminal may be measured and monitored and the database may be searched for the current transmission conditions and associated properties of the communication link in order to determine a geographical location of the mobile terminal. For example, the database may be searched for transmission conditions matching those currently being used by the mobile terminal. If several transmission condition group candidates are found, then transmission property values of each transmission condition group candidate may be compared with properties of the current communication link of the mobile terminal. The transmission condition group stored in the database and having transmission property values closest to the properties of the current communication link may be selected, and a geographical location linked to the selected transmission condition group may be selected as the geographical location of the mobile terminal. This embodiment may be used to determine the geographical location of a mobile terminal not equipped with a positioning device.

The embodiments of the invention may be realized in an apparatus comprising a processing unit. The processing unit may be configured to perform at least some of the steps described in connection with the flowcharts of FIGS. 4 and 5 and in connection with FIG. 3. The embodiments may be implemented as a computer program comprising instructions for executing a computer process for adapting a communication link between a mobile terminal and a base station of a mobile telecommunication system on the basis of the monitored movement of the mobile terminal.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

As a general remark, embodiments of the invention may be used as a supporting solution for managing transmission conditions in a mobile telecommunication system. In other words, regular handover and radio resource management operations may be used together with the embodiments of the invention. For example, management of the transmission conditions may be performed within the scope of available resources (for example available frequencies allocated to a base station). Otherwise, the change of transmission conditions may be negotiated with a higher layer unit (for example a radio network controller), or the change of transmission conditions may be affected in another way, as described above.

Even though the invention has been described above with reference to an example according to the accompanying drawings, it is clear that the invention is not restricted thereto but it can be modified in several ways within the scope of the appended claims.

1. A method, comprising:
monitoring movement of a mobile terminal having a communication link with a base station of a mobile telecommunication system;
checking a database for transmission conditions of the communication link that are most optimal according to a determined optimality criterion for current movement of the mobile terminal; and
taking action to change the transmission conditions of the communication link upon detecting, in the database, the transmission conditions providing a more optimal communication link for the current movement of the mobile terminal than the transmission conditions currently being used for the communication link.

2. The method of claim 1, further comprising:
predicting future movement of the mobile terminal from the monitored movement of the mobile terminal;
checking the database for the transmission conditions of the communication link that are the most optimal according to the determined optimality criterion for a geographical location associated with the predicted movement of the mobile terminal, and
taking action to change the transmission conditions of the communication link upon detecting, in the database, the transmission conditions providing a more optimal communication link for a predicted geographical location than the transmission conditions currently being used for the communication link.

3. The method of claim 1, further comprising:
storing in the database information on properties of the communication link with different transmission conditions available to the mobile terminal in different geographical locations.

4. The method of claim 1, wherein the checking of the database further comprises
reading transmission property values linked to the geographical location associated with a predicted movement of the mobile terminal,
selecting one of the transmission property values according to the determined optimality criterion, and
selecting transmission conditions linked to the selected transmission property value.

5. The method of claim 1, further comprising:
transferring information on the movement of the mobile terminal between the mobile terminal and the base station as signaling information according to a communication protocol used in the communication link between the mobile terminal and the base station.

6. The method of claim 1, further comprising:
measuring a communication link quality indicator from a received signal transmitted with given transmission conditions from a given geographical location;
obtaining knowledge of the given transmission conditions and the given geographical location associated with the transmission of the received signal;
storing in the database the measured communication link quality indicator as a transmission property value of the communication link together with the transmission conditions and the given geographical location, and
repeating the measurement of the communication link quality indicator, obtaining the knowledge, and storing operations for received signals transmitted with different transmission conditions and from different geographical locations to construct the database comprising a plurality of geographical locations and at least one transmission property value obtainable from each of the plurality of geographical locations with given transmission conditions.

7. The method of claim 6, further comprising:
linking the transmission property value with the transmission conditions to the transmission conditions used in the transmission of the signal, from which the communication link quality indicator is measured, and to the geographical location from which the measured signal is transmitted.

8. The method of claim 6, wherein the measured communication link quality indicator is a measured level of the received signal.

9. The method according to any of claims 6, further comprising storing a cost of the communication link as a second transmission property value in the database.

10. The method of claim 1, further comprising:
monitoring a measured reception signal level of a signal received from a transmitter of the communication link, and
utilizing the reception signal level when checking the database for the most optimal transmission conditions.

11. The method of claim 10, further comprising:
weighting database values used as the optimality criterion with the monitored reception signal level.

12. The method of claim 1, wherein the transmission conditions comprise at least one of the following: a transmission frequency, a serving base station, and a bearing of the mobile terminal.

13. The method of claim 1, wherein taking the action to change the transmission conditions of the communication link comprises at least one of the following:
selecting a radio system providing a more optimal connection in the geographical location of the mobile terminal, and
changing a transmission frequency of the communication link.

14. The method of claim 1, wherein taking the action to change the transmission conditions comprises instructing a user of the mobile terminal to move to a geographical location in which a higher reception signal level is achieved with a same transmission power level as that currently being used in a current location.

15. The method of claim 1, further comprising:
instructing a user of the mobile terminal to change a bearing of the mobile terminal to a bearing providing, according to information contained in the database, a higher reception signal level with a same transmission power level.

16. The method of claim 1, wherein optimality is defined as at least one of the following criteria: a higher reception signal level, a lower power consumption of a transmitter, and a lower data transmission cost.

17. The method of claim 1, further comprising:
predicting a geographical area that the mobile terminal will be entering; and
changing the transmission conditions of the communication link to ones that are optimal for the geographical area the mobile terminal will be entering.

18. The method of claim 1, further comprising:
storing the database in an element of a radio access network of the mobile telecommunication system; and
receiving information of a geographical location of the mobile terminal from the mobile terminal.

19. The method of claim 1, wherein the database is stored in the mobile terminal.

20. The method of claim 1, further comprising:
monitoring the geographical location of the mobile terminal with a satellite positioning system.

21. An apparatus, comprising:
an interface configured to receive information on a geographical location of a mobile terminal having a communication link with a base station of a mobile telecommunication system; and
a processing unit configured to check a database for transmission conditions of the communication link that are most optimal according to a determined optimality criterion for current movement of the mobile terminal, and to take action to change the transmission conditions of the communication link upon detecting, in the database, the transmission conditions providing a more optimal communication link for the current movement of the mobile terminal than the transmission conditions currently being used for the communication link.

22. The apparatus of claim 21, wherein the processing unit is further configured to predict future movement of the mobile terminal from a monitored movement of the mobile terminal, to check the database for transmission conditions of the communication link that are the most optimal according to the determined optimality criterion for a geographical location associated with the predicted movement of the mobile terminal, and to take action to change the transmission conditions of the communication link upon detecting, in the database, the transmission conditions providing a more optimal communication link for a predicted geographical location than the transmission conditions currently being used for the communication link.

23. The apparatus of claim 21, wherein the database comprises information on properties of the communication link with different transmission conditions available to the mobile terminal in different geographical locations.

24. The apparatus of claim 21, wherein the processing unit is further configured to check the database by reading transmission property values linked to the geographical location associated with a predicted movement of the mobile terminal, selecting one of the transmission property values according to the determined optimality criterion, and selecting transmission conditions linked to the selected transmission property value.

25. The apparatus of claim 21, wherein the processing unit is further configured to support transfer of information on the movement of the mobile terminal between the mobile terminal and the base station as signaling information according to a communication protocol used in the communication link between the mobile terminal and the base station.

26. The apparatus of claim 21, wherein the processing unit is further configured to measure a communication link quality indicator from a received signal transmitted with given transmission conditions from a given geographical location, to obtain knowledge of the given transmission conditions and the given geographical location associated with the transmission of the received signal, to store in the database the measured communication link quality indicator as a transmission property value of the communication link together with the given transmission conditions and the given geographical location into the database, and to repeat the measurement of the communication link quality indicator, obtaining the knowledge, and storing operations for received signals transmitted with different transmission conditions and from different geographical locations to construct the database comprising a plurality of geographical locations and at least one transmission property value obtainable from each of the plurality of geographical locations with given transmission conditions.

27. The apparatus of claim 26, wherein the processing unit is further configured to link the transmission property value with the transmission conditions to the transmission conditions used in the transmission of the measured signal, from which the communication link quality indicator is measured, and to the geographical location from which the measured signal is transmitted.

28. The apparatus of claim 26, wherein the processing unit is further configured to store in the database a cost of the communication link as another transmission property value.

29. The apparatus of claim 21, wherein the processing unit is further configured to monitor a measured reception signal level of a signal received from a transmitter of the communication link, and to utilize the reception signal level when checking the database for the most optimal transmission conditions.

30. The apparatus of claim 29, wherein the processing unit is further configured to weight database values used as the optimality criterion with the monitored reception signal level.

31. The apparatus of claim 21, wherein the transmission conditions comprise at least one of the following: a transmission frequency, a serving base station, and a bearing of the mobile terminal.

32. The apparatus of claim 21, wherein the processing unit is further configured to take the action to change the transmission conditions of the communication link by performing at least one of the following:
selecting a radio system providing a more optimal connection in the geographical location of the mobile terminal, and
changing a transmission frequency of the communication link.

33. The apparatus of claim 21, wherein the processing unit is further configured to change the transmission conditions by instructing a user of the mobile terminal to move the mobile terminal to a geographical location in which a higher reception signal level is achieved with a same transmission power level as that currently being used in a current location.

34. The apparatus of claim 21, wherein the processing unit is further configured to change the transmission conditions by instructing a user of the mobile terminal to change a bearing of the mobile terminal to a bearing providing, according to information contained in the database, a higher reception signal level with a same transmission power level.

35. The apparatus of claim 21, wherein the processing unit is further configured to select the optimality criterion from the following criteria: a higher reception signal level, a lower power consumption of a transmitter, and a lower data transmission cost.

36. The apparatus of claim 21, wherein the processing unit is further configured to predict a geographical area the mobile terminal will be entering, and to change the transmission conditions of the communication link to ones that are optimal for the geographical area the mobile terminal will be entering.

37. The apparatus of claim 21, wherein the apparatus is an element of a radio access network of the mobile telecommunication system, further comprising a memory unit configured to store the database, the element being further configured to receive the information of a geographical location of the mobile terminal from the mobile terminal.

38. The apparatus of claim 21, wherein the apparatus is the mobile terminal further comprising:
a memory unit configured to store the database, and
a positioning device configured to monitor the geographical location of the mobile terminal and to output the geographical locations to the processing unit.

39. An apparatus, comprising:
means for monitoring movement of a mobile terminal having a communication link with a base station of a mobile telecommunication system;
means for checking a database for transmission conditions of the communication link that are most optimal according to a determined optimality criterion for current movement of the mobile terminal; and
means for taking action to change the transmission conditions of the communication link upon detecting, in the database, the transmission conditions providing a more optimal communication link for the current movement of the mobile terminal than the transmission conditions currently being used for the communication link.

40. A computer program distribution medium readable by a computer and encoding a computer program of instructions for executing a computer process, comprising:
monitoring movement of a mobile terminal having a communication link with a base station of a mobile telecommunication system;
checking a database for transmission conditions of the communication link that are most optimal according to a determined optimality criterion for current movement of the mobile terminal; and
taking action to change the transmission conditions of the communication link upon detecting, in the database, the transmission conditions providing a more optimal communication link for the current movement of the mobile terminal than the transmission conditions currently being used for the communication link.

41. A data structure, comprising:
a first data field comprising a plurality of location values representing different geographical locations;
a second data field comprising a plurality of transmission condition sets, wherein each transmission condition set is linked to one of the plurality of location values and each transmission condition set comprises one or more transmission condition groups comprising one or more transmission conditions; and
a third data field comprising a plurality of transmission property values representing quality of transmission, wherein each transmission quality value is linked to a transmission condition group.
